(19) United States
(12) Patent Application Publication
(10) Pub. No.: US 2009/0195562 A1
(43) Pub. Date: Aug. 6, 2009

(54) Display Device and Driving Method Thereof

(75) Inventors: Chun-Kai Huang, Hsin-Chu (TW); Kung-Yi Chan, Hsin-Chu (TW); Huan-Hsin Li, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 12/128,885

(22) Filed: May 29, 2008

(30) Foreign Application Priority Data
Feb. 1, 2008 (TW) 97104060

(51) Int. Cl. G09G 5/10; G09G 3/20

(52) U.S. Cl. 345/690; 345/55

(57) ABSTRACT

A driving method for driving a display device is provided. The driving device includes at least a pixel. The pixel has a first, a second, and a third sub-pixels respectively associated with three primary colors. The driving method includes the steps of driving the first, second and third sub-pixels respectively in accordance with a first, a second and a third driving sequences during a first, a second and a third frame periods. Moreover, the first, the second and the third driving sequences are different from each other. A display device applying said driving method is also provided herein.

### RELATED APPLICATIONS

This application claims priority to Taiwan Patent Application Serial Number 97104060, filed Feb. 1, 2008, which is herein incorporated by reference.

### BACKGROUND

1. Field of Invention

The invention relates to a display device and driving method thereof, and more particularly, to a flat display device and a driving method thereof.

2. Description of Related Art

Generally speaking, display devices comprise a plurality of pixels arranged in a matrix form, and each pixel is composed of a red, green and blue colored sub-pixel. In the driving method implemented by conventional display devices, all sub-pixels on a row of pixels are driven with a single driving sequence. For a viewer, the conventional display device has color shifting problems, i.e., the frame color displayed is different from a predetermined color. For example, the frame color is too warm and the frame would tend to be red or yellow. To reduce the effects of the color shifting problem, the viewer can adjust the color temperature using the on-screen display (OSD) menu of the display device, i.e. increasing the color temperature if the frame is originally too warm, so as to turn the frame color to a colder color, and thus easing the color shifting problem. However, the adjusted display device is incapable of displaying a warm color frame precisely, thus the quality of the display is decreased.

Therefore, a new display device and driving method thereof should be provided with the intention to reduce the effects of aforesaid color shifting problem and provide a high-quality frame displayed on the display device.

### SUMMARY

Accordingly, one aspect of the invention is directed to a display device, sub-pixels of the display device are driven in accordance with multiple driving sequences in different frame periods, and thus the color-shifting problem is eliminated.

Another aspect of the invention is directed to a method of driving a display device. The method is meant to drive sub-pixels of the display device in accordance with multiple driving sequences in consecutive frame period, and thus eliminate the color-shifting problem and acquire a variety of frame colors.

The invention provides a display device, which comprises a substrate, a plurality of scan lines, a plurality of data lines, a plurality of pixels, and a signal generator. The data lines and the scan lines interlace with each other are both positioned on the substrate. The pixels arranged in a matrix are configured to respectively connect with the scan lines and the data lines, and each of the pixels comprises a first, a second and a third sub-pixel, respectively associated with a first, a second, and a third primary color. The signal generator is connected with the scan lines and is configured to drive the first, the second and the third sub-pixel with a first, a second, and a third driving sequence respectively in a first, a second, and a third frame period, where the first, the second and the third driving sequence are different from each other.

Moreover, the invention provides a method of driving a display device. The display device comprises a pixel having a first, a second, and a third sub-pixel, respectively associated with a first primary color, a second primary color, and a third primary color. The method comprises the step of respectively driving the first, the second and the third sub-pixels in accordance with a first driving sequence during a first frame period, the step of respectively driving the first, the second and the third sub-pixel in accordance with a second driving sequence during a second frame period, and the step of respectively driving the first, the second and the third sub-pixel in accordance with a third driving sequence during a third frame period. The first, the second and the third driving sequences described above are different from each other.

According to a preferred embodiment of the invention, the first, the second and the third sub-pixels are sequentially driven with the first driving sequence. The second, the third and the first sub-pixel are sequentially driven with the second driving sequence. The third, the first and the second sub-pixels are sequentially driven with the third driving sequence. Also, a common signal with a first and a second voltage levels is provided to the first, the second and the third sub-pixel during two consecutive frame periods, and the first and second voltage levels are different from each other.

On the other hand, the invention also provides a method of driving a display device. The display device comprises a pixel having a first, a second, and a third sub-pixels, respectively associated with a first primary color, a second primary color, and a third primary color. The method may comprise a step of respectively driving the first, the second and the third sub-pixels in accordance with a first driving sequence during a first frame period, a step of respectively driving the first, the second and the third sub-pixel in accordance with a second driving sequence during a second frame period, a step of respectively driving the first, the second and the third sub-pixel in accordance with a third driving sequence during a third frame period, a step of respectively driving the first, the second and the third sub-pixel in accordance with a fourth driving sequence during a fourth frame period, a step of respectively driving the first, the second and the third sub-pixel in accordance with a fifth driving sequence during a fifth frame period, and a step of respectively driving the first, the second and the third sub-pixel in accordance with a sixth driving sequence during a sixth frame period. The first, the second, the third, the fourth, the fifth and the sixth driving sequences described above are different from each other.

According to a preferred embodiment of the invention, the first, the second and the third sub-pixel are sequentially driven in accordance with the first driving sequence. The first, the third and the second sub-pixel are sequentially driven in accordance with the second driving sequence. The second, the first and the third sub-pixel are sequentially driven in accordance with the third driving sequence. The second, the third and the first sub-pixel are sequentially driven in accordance with the fourth driving sequence. The third, the first and the second sub-pixel are sequentially driven in accordance with the fifth driving sequence. The third, the second and the first sub-pixel are sequentially driven in accordance with the sixth driving sequence. Also, a common signal with a first voltage level and a second voltage level is provided to the first, the second and the third sub-pixel during two consecutive frame periods, and the first and second voltage levels are different from each other.

### BRIEF DESCRIPTION OF THE DRAWINGS

FIG. 1 is a schematic graph illustrating a liquid crystal display implementing multiple driving sequences for driving sub-pixels in accordance with a preferred embodiment of the invention.

FIG. 2 is a schematic graph illustrating a method for driving a liquid crystal display in accordance with a preferred embodiment of the invention.

FIG. 3 is a timing diagram showing data signals and a common voltage with multiple driving sequences in accordance with the method of FIG. 2.

FIG. 4 is a timing diagram showing data signals and a common voltage with multiple driving sequences in accordance with another embodiment of the invention.

FIG. 5 is a flow chart of the driving method in accordance with a preferred embodiment of the invention.

FIG. 6 is a flow chart of the driving method in accordance with another preferred embodiment of the invention.

### DESCRIPTION OF THE PREFERRED EMBODIMENTS

For eliminating the color shifting problem, embodiments of the invention provides methods of driving a display device and the display device implementing the methods, e.g., a liquid crystal display. However, in other embodiment, the display device could also be a plasma display and an electronic paper display.

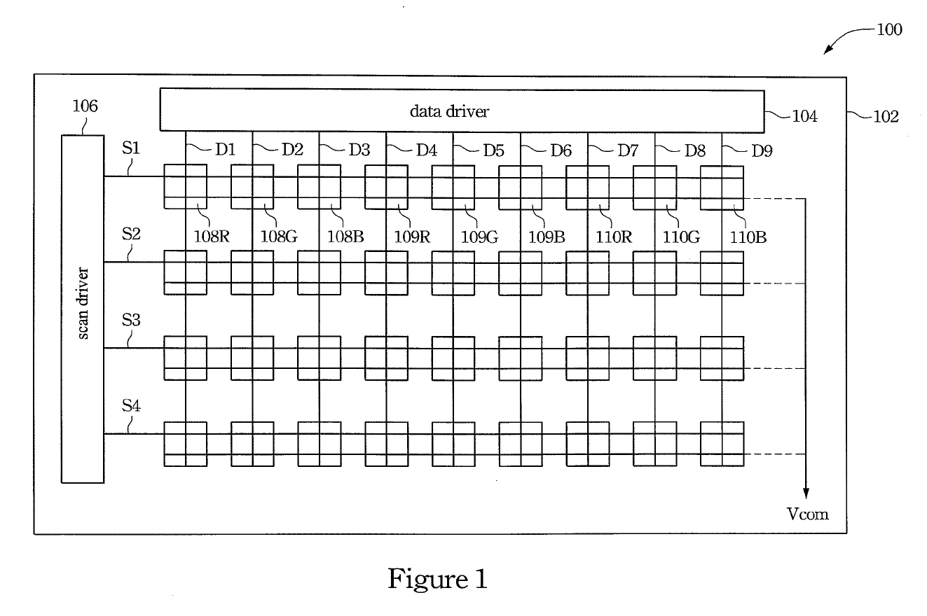

FIG. 1 is a schematic graph illustrating a liquid crystal display implementing multiple driving sequences for driving sub-pixels in accordance with a preferred embodiment of the invention. Referring to FIG. 1, in the embodiment, the display device 100 comprises a substrate 102, scan lines S1˜S4, data lines D1˜D9, sub-pixels 108R˜110B, a data driver 104 and a scan driver 106. The scan lines S1˜S4 and the data lines D1˜D9, interlacing each other, are formed on the substrate 102. The sub-pixels 108R˜110B are arranged in a matrix, and the sub-pixel 108R is connected with the data line D1 and the scan line S1, the sub-pixel 108G is connected with the data line D2 and the scan line S1, and so on. For example, the sub-pixel 108R, 108G, and 108B would respectively emit red (R), green (G) and blue (B) light, and the sub-pixels would constitute a pixel, the gray levels of each of the sub-pixels determine the color of the pixel.

The scan driver 106 is connected with the scan lines S1˜S4, and with a scan signal received from the scan driver 106, the sub-pixels 108R˜110B are enabled by way of the scan line S1. A data driver 104 is connected with scan lines D1˜D9, and with data signals received from the data driver 104, sub-pixels 108R˜110B are driven by way of the data lines D1˜D9, so as to display predetermined gray scales.

During different frame periods, data driver outputs data signals in accordance with a first, a second, a third, a fourth, a fifth, and a sixth driving sequence to data lines D1˜D9 to respectively drive sub-pixels 108R˜110B, where the six driving sequences can be different from each other.

Take the sub-pixels 108R˜108B for example, the sub-pixels 108R, 108G and 108B are sequentially driven with data signals sequentially transmitted by the data line D1˜D3 in accordance with the first driving sequence. With a similar manner, the sub-pixels 108B, 108G and 108R are sequentially in accordance with the second driving sequence. The sub-pixels 108B, 108R and 108G are sequentially driven in accordance with the third driving sequence. The sub-pixels 108G, 108B and 108R are sequentially driven in accordance with the fourth driving sequence. The sub-pixels 108G, 108R and 108B are sequentially driven in accordance with the fifth driving sequence. The sub-pixels 108R, 108B and 108G are sequentially driven in accordance with the sixth driving sequence. The aforesaid driving sequences can also be implemented to drive the sub-pixels 109R˜109B and 110R˜110B.

As described above, the embodiment implements different driving sequences to drive sub-pixels respectively associated with different primary colors, so as to acquire a high display quality.

Moreover, multiple driving sequences are provided to drive sub-pixels associated with different primary colors, so as to avoiding a blurred edge of a moving image to increase the display quality of the moving image.

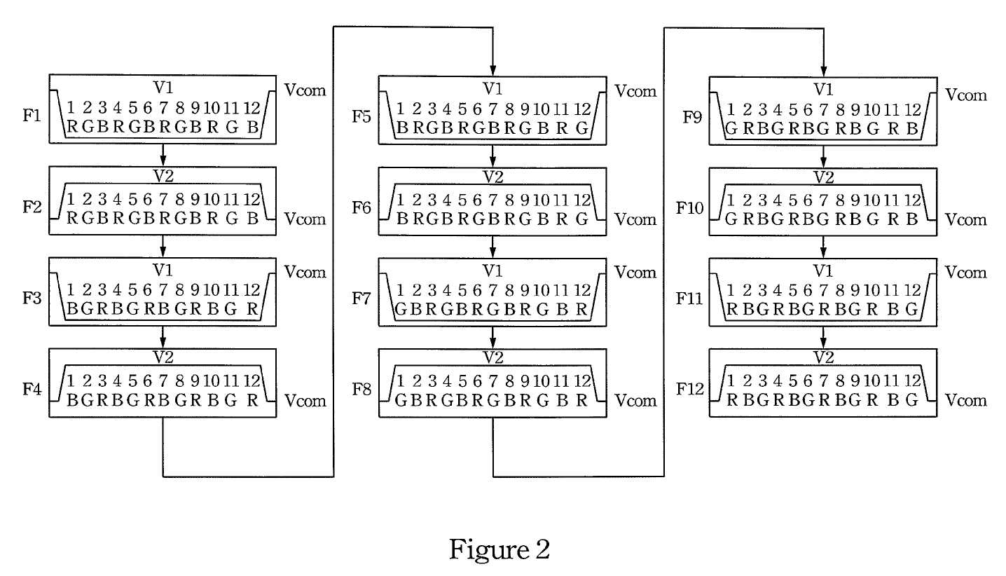

FIG. 2 is a schematic graph illustrating a method for driving a liquid crystal display in accordance with a preferred embodiment of the invention. With reference to FIG. 1 and FIG. 2, the embodiment implements six driving sequences to drive sub-pixels of the liquid crystal display. It should be noted that the numbers 1˜12 represents driving sequences of a row of sub-pixels, and the letters R, G, and B respectively represent sub-pixels associated with red (R), green (G), and blue (B) colors of a pixel, and four pixels are illustrated in FIG. 2. Preferably, the first to the sixth driving sequences are respectively implemented in the frames F1 and F2, frames F3 and F4, frames F5 and F6, frames F7 and F8, frames F9 and F10, and frames F11 and F12. For example, consecutive frames F1 and F2 both implement the first driving sequence. The sub-pixels 108R˜110B respectively receive a common voltage signal Vcom with a first level V1 (e.g. low voltage level) during the frame F1 time, and the sub-pixels 108R˜110B respectively receive the common voltage signal Vcom with a second level V2 (e.g. low voltage level) during the frame F2 time. The first level is different from the second level. Also, two consecutive frames F3 and F4, frames F5 and F6, frames F9 and F10, frames F11 and F12 can respectively implement the same driving sequence and the common voltage signal Vcom with different levels, so as to protect the property of the liquid crystal molecules from deterioration.

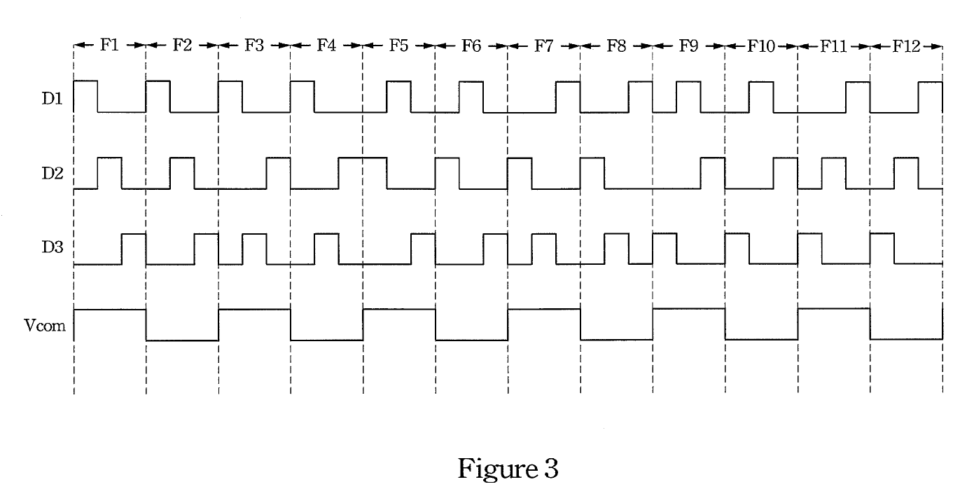

As can be seen from FIG. 2, the data driver 104 sequentially drives sub-pixels 108R, 108G, 108B, 109R, 109G, 109B, 110R, 110G, and 110B with a first driving sequence during the frame time F1. The data driver 104 sequentially drives sub-pixels 108B, 108G, 108R, 109B, 109G, 109R, 110B, 110G, and 110R with a second driving sequence during the frame time F3 period. The data driver 104 sequentially drives sub-pixels 108B, 108R, 108G, 109B, 109R, 109G, 110B, 110R, and 110G with a third driving sequence during the frame F5 period. The data driver 104 sequentially drives sub-pixels 108G, 108B, 108R, 109G, 109B, 109R, 110G, 110B, and 110R with a fourth driving sequence during the frame F7 period. The data driver 104 sequentially drives sub-pixels 108G, 108R, 108B, 109G, 109R, 109B, 110G, 110R, and 110B with a fifth driving sequence during the frame F9 period. The data driver 104 sequentially drives sub-pixels 108R, 108G, 108B, 109R, 109G, 109B, 110R, 110G and 110B with a sixth driving sequence during the frame F11 period. FIG. 3 is a timing diagram showing data signals and a common voltage with multiple driving sequences in accordance with the method of FIG. 2. With reference to FIG. 1 and FIG. 3, FIG. 3 illustrates data signals configured to drive the sub-pixels 108R, 108G and 108B on the data lines D1, D2 and D3, and vibrations of the level of the common voltage signal Vcom. During the frame F1 to the frame F12 period, data driver 104 can respectively drive the sub-pixels 108R, 108G and 18B respectively in accordance with the first to the sixth driving sequences, and in two consecutive frame period, the sub-pixels 108R, 108G and 108B respectively receive a common voltage signal with different level to protect the liquid crystal molecule of the liquid crystal display from deterioration.

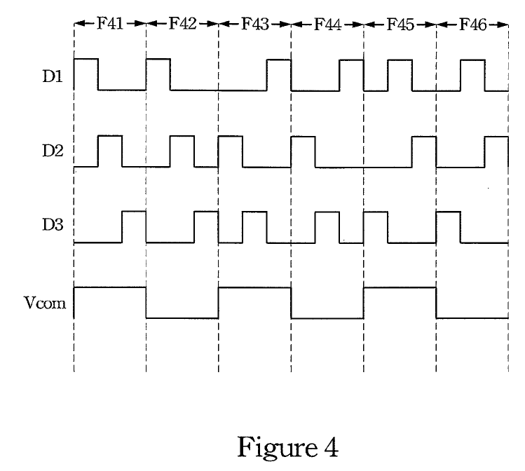

FIG. 4 is a timing diagram showing data signals and a common voltage with multiple driving sequences in accordance with another embodiment of the invention. With reference to FIG. 1 and FIG. 4, the embodiment implements three driving sequences to drive sub-pixels of the liquid crystal display during different frame period. Likely, FIG. 4 illustrates data signals configured to drive the sub-pixel 108R, 108G and 108B on the data line D1, D2 and D3, and vibrations of the levels of the common voltage signal Vcom. The data driver 104 drives the sub-pixels 108R, 108G and 108B in accordance with the first, the fourth, and the third driving sequences shown in the FIG. 3, so as to eliminate the color shifting problem. The sub-pixels 108R, 108G, and 108B respectively receive the common voltage signal Vcom with different levels in two consecutive frames F41 and F42, frames F43 and F44, frames F45 and F46, such that the liquid crystal molecule of the liquid crystal display will not suffer from deterioration. Besides, in the embodiment, the method of driving the liquid crystal display selectively implements the second, the fifth, and the six driving sequences shown in FIG. 3, to replace the driving sequences illustrated in the FIG. 4, so as to eliminate the color shifting problem.

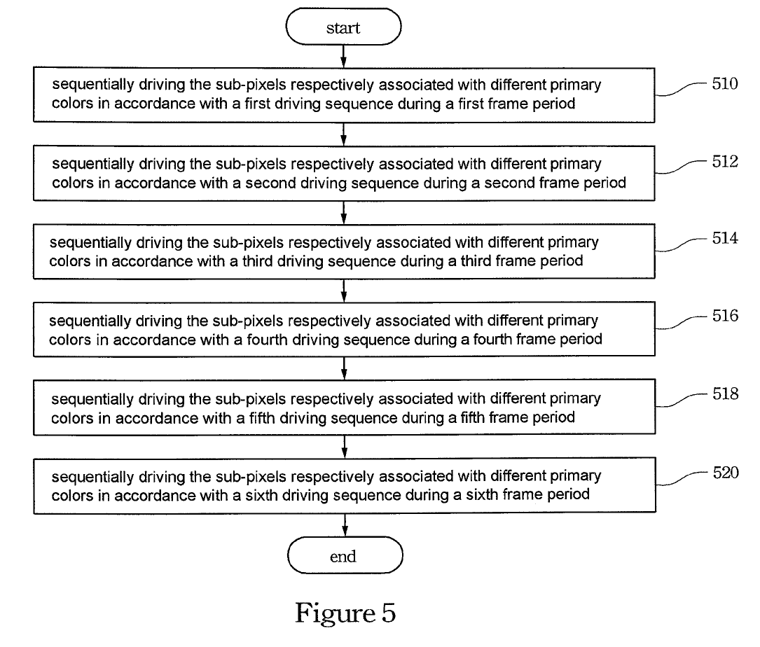

In still one embodiment, a method is provided to drive a display device, as shown in FIG. 1. A plurality of pixels are formed on the substrate 102 of the liquid crystal display 100, each pixel has three sub-pixels, i.e., the sub-pixel 108R, 108G, and 108B, respectively associated with one primary color, i.e., the red, green and blue colors. FIG. 5 is a flow chart of the driving method in accordance with a preferred embodiment of the invention. With reference to FIG. 1 and FIG. 5, according to the driving method, the data driver 104 sequentially drives the sub-pixel 108R, 108G, and 108B in accordance with a first driving sequence during a first frame period, in the step 510. Also, the data driver 104 sequentially drives the sub-pixels 108B, 108G, and 108R in accordance with a second driving sequence during a second frame period (step 512). In the step 514, the data driver 104 sequentially drives the sub-pixels 108B, 108R, and 108G in accordance with a third driving sequence during a third frame period. The data driver 104 sequentially drives the sub-pixels 108G, 108B, and 108R in accordance with a fourth driving sequence during a fourth frame period in the step 516. Also, the data driver 104 sequentially drives the sub-pixels 108G, 108R, and 108B in accordance with a fifth driving sequence during a fifth frame period (step 518). In the step 520, the data driver 104 sequentially drives the sub-pixel 108B, 108R, and 108G in accordance with a sixth driving sequence during a sixth frame period.

In the embodiment, the method of driving the liquid crystal device implements multiple driving sequences to sequentially drive sub-pixels associated with different primary colors, and thus the color shifting problem can be eliminated.

Besides, the method of driving the liquid crystal device selectively providing the common voltage signal Vcom with different levels to the sub-pixels, so as to protect the liquid crystal molecule of the liquid crystal display from deterioration.

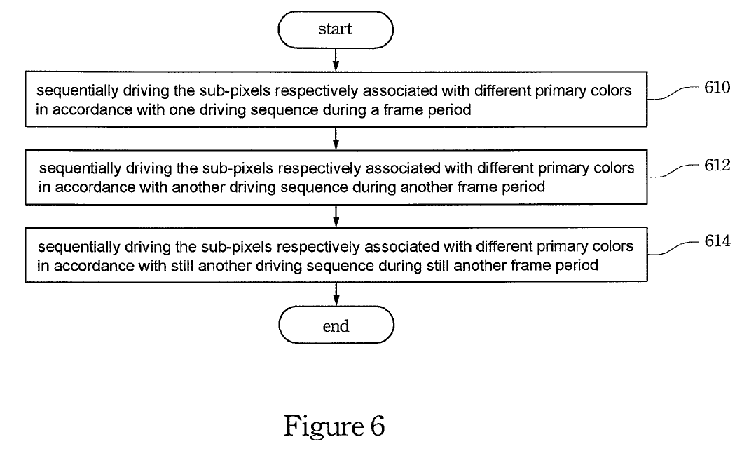

In still another embodiment of the invention, a method of driving a display is provided to sequentially drive the sub-pixels 108R, 108G, and 108B. FIG. 6 is a flow chart of the driving method in accordance with the embodiment of the invention. With reference to FIG. 1 and FIG. 6, according to the method, the data driver 104 sequentially drives the sub-pixels 108R, 108G, and 108B in accordance with one driving sequence during one frame period in the step 610. Also, the data driver 104 sequentially drives the sub-pixels 108B, 108R, and 108G in accordance with another driving sequence during another frame period in step 612. In step 614, the data driver 104 sequentially drives the sub-pixels 108G, 108B, and 108R in accordance with still another driving sequence during still another frame period.

In the embodiment, the method of driving the liquid crystal device implements multiple driving sequences to sequentially drive sub-pixels associated with different primary colors, and thus the color shifting problem can be eliminated.

Furthermore, the method of driving the liquid crystal device selectively provides the common voltage signal Vcom with different levels to the sub-pixels, so as to protect the liquid crystal molecule of the liquid crystal display from deterioration.

As described above, the display device and method of driving the display device both implement multiple driving sequences to sequentially drive sub-pixels associated with different primary colors, so as to eliminate the color shifting problem of the display device and acquire a high display quality.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A display device, comprising:
a substrate;
a plurality of scan lines;
a plurality of data lines configured to interlace with the scan lines on the substrate;
a plurality of pixels arranged in a matrix and configured to respectively connect with the scan lines and data lines, each of the pixels comprising a first, a second and a third sub-pixels, respectively associated with a first, a second and a third primary colors; and
a signal generator connected with the scan lines and configured to respectively drive the first, the second and the third sub-pixels with a first, a second, and a third driving sequences during a first, a second, and a third frame periods, wherein the first, the second and the third driving sequences are different from each other.

2. The display device of claim 1, wherein the signal generator is adapted to sequentially drive the first, the second and the third sub-pixels in accordance with the first driving sequence.

3. The display device of claim 1, wherein the signal generator is adapted to sequentially drive the second, the third and the first sub-pixels in accordance with the second driving sequence.

4. The display device of claim 1, wherein the signal generator is adapted to sequentially drive the third, the first and the second sub-pixels in accordance with the third driving sequence.

5. The display device of claim 1, wherein the signal generator is adapted to respectively provide a common signal with a first and a second voltage levels to the first, the second and the third sub-pixels during two consecutive frame periods, and the first and second voltage levels are different from each other.

6. The display device of claim 1, wherein the signal generator is adapted to drive the first, the second and the third sub-pixels with a fourth, a fifth, and a sixth driving sequences respectively in a fourth, a fifth and a sixth frame period, and the first, second, third, fourth, fifth and sixth driving sequences are different from each other.

7. The display device of claim 6, wherein the signal generator is adapted to sequentially drive the first, the third and the second sub-pixels in accordance with the fourth driving sequence, sequentially drives the second, the first and the third sub-pixels in accordance with the fifth driving sequence, and sequentially drives the third, the second and the first sub-pixels in accordance with the sixth driving sequence.

8. The display device of claim 6, wherein the signal generator is adapted to respectively provide a common signal with a first and a second voltage level to the first, the second and the third sub-pixels during two consecutive frame periods, and the first and second voltage levels are different from each other.

9. A method of driving a display device, the display device comprising a pixel having a first, a second, and a third, respectively associated with a first, a second, and a third primary colors, the method comprising the steps of:
respectively driving the first, the second and the third sub-pixels in accordance with a first driving sequence during a first frame period;
respectively driving the first, the second and the third sub-pixels in accordance with a second driving sequence during a second frame period; and
respectively driving the first, the second and the third sub-pixels in accordance with a third driving sequence during a third frame period;
wherein the first, the second and the third driving sequences are different from each other.

10. The method of claim 9, wherein the first, the second and the third sub-pixels are sequentially driven in accordance with the first driving sequence.

11. The method of claim 9, wherein the second, the third and the first sub-pixels are sequentially driven in accordance with the second driving sequence.

12. The method of claim 9, wherein the third, the first and the second sub-pixels are sequentially driven in accordance with the third driving sequence.

13. The method of claim 9, further comprising providing a common signal with a first voltage level and a second voltage level to the first, the second and the third sub-pixels during two consecutive frame periods, wherein the first and second voltage levels are different from each other.

14. A method of driving a display device, the display device comprising a pixel having a first, a second and a third pixels, respectively associated with a first, a second, and a third primary colors, the method comprising the steps of:
respectively driving the first, the second and the third sub-pixels in accordance with a first driving sequence during a first frame period;
respectively driving the first, the second and the third sub-pixels in accordance with a second driving sequence during a second frame period;
respectively driving the first, the second and the third sub-pixels in accordance with a third driving sequence during a third frame period;
respectively driving the first, the second and the third sub-pixels in accordance with a fourth driving sequence during a fourth frame period;
respectively driving the first, the second and the third sub-pixels in accordance with a fifth driving sequence during a fifth frame period; and
respectively driving the first, the second and the third sub-pixels in accordance with a sixth driving sequence during a sixth frame period;
wherein the first, the second, the third, the fourth, the fifth and the sixth driving sequences are different from each other.

15. The method of claim 14, wherein the first, the second and the third sub-pixels are sequentially driven in accordance with the first driving sequence.

16. The method of claim 14, wherein the first, the third and the second sub-pixels are sequentially driven in accordance with the second driving sequence.

17. The method of claim 14, wherein the second, the first and the third sub-pixels are sequentially driven in accordance with the third driving sequence.

18. The method of claim 14, wherein the second, the third and the first sub-pixels are sequentially driven in accordance with the fourth driving sequence.

19. The method of claim 14, wherein the third, the first and the second sub-pixels are sequentially driven in accordance with the fifth driving sequence.

20. The method of claim 14, further comprising providing a common signal with a first voltage level and a second voltage level to the first, the second and the third sub-pixels during two consecutive frame periods, wherein the first and second voltage levels are different from each other.
